(19) United States
(12) Patent Application Publication
(10) Pub. No.: US 2014/0279213 A1
(43) Pub. Date: Sep. 18, 2014

(54) SYSTEM AND METHOD FOR INVITING GIFT SELECTION ON A NETWORK-ENABLED INTERFACE

(71) Applicants: Richard Swenson, Yreka, CA (US); Nick Rouhier, Yreka, CA (US)

(72) Inventors: Richard Swenson, Yreka, CA (US); Nick Rouhier, Yreka, CA (US)

(21) Appl. No.: 13/837,347

(22) Filed: Mar. 15, 2013

(51) Int. Cl. G06Q 30/06

(52) U.S. Cl. CPC G06Q 30/0633
USPC 705/26.8

(57) ABSTRACT

A system and method for inviting gift selection on a network-enabled interface are disclosed. A particular embodiment includes: enabling a gifter to create, by use of a network-connectable data processor, a gift page including, a plurality of gift item options sourced from a plurality of gift sources; enabling the gifter to identify a giftee for whom the gift page is created; causing, by use of the data processor, delivery of a notification to the giftee, the notification including a link to the gift page; enabling the giftee to select one or more gift item options from the gift page; communicating the selected gift item options to the gifter; and enabling the gifter to effect fulfillment of the selected gift item options.

### TECHNICAL FIELD

This patent application relates to computer-implemented software and networked systems, according to one embodiment, and more specifically to a system and method for inviting gift selection on a network-enabled interface.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form to part of this document: Copyright 2012-2013 RBMJ Inc., All Rights Reserved.

### BACKGROUND

It can be a frustrating experience to select and purchase gifts for someone special. Many gift options have style elements that the gifter (the person giving the gift) may not recognize as desired or undesired by the giftee (the person receiving the gift). Gift options may also come in various sizes and colors, which may also confuse the gifter. As a result, the gifter must guess at the best gift option for a particular giftee. At the same time the giftee may be put in the awkward situation of accepting a gift that doesn't fit the giftee's taste or size.

Online shopping has become very popular as Internet usage has expanded. Online shopping will continue to grow as the use of mobile devices becomes ubiquitous. However, even though shoppers can browse the product lines of a variety of online retailers or compile a wish list of desired items, the use of technology has not solved the gift buying or gift receiving experience.

### SUMMARY

In various example embodiments, a system and method for inviting gift selection on a network-enabled interface are disclosed. In various example embodiments as described herein, the gift buying and gift receiving experience is significantly improved. In one embodiment, a gifter can give to a giftee a gift page full of gift offerings from which the giftee gets to choose. The gifter can generate the gift page with as variety of gift item options from a variety of sources, including online retailers, offline retailers, giftee-generated gift lists, and/or other gift sources. The gift page is thereby customized and personalized for at particular giftee. The gift page can also be configured with a set of parameters and/or customized for a particular occasion. The gifter can offer the personalized gift page to the giftee and enable the giftee to choose one or more gift items from the gift page. The various embodiments also provide the ability for social interaction between gifter and giftee.

In a particular example embodiment described in more detail below, a network-enabled system allows registered users (e.g., gifters) to shop at in retailer or from any merchant on the Internet using a bookmarklet. In one embodiment, a bookmarklet is unobtrusive script written in JavaScript and stored as the Uniform Resource Locator (URL) of a bookmark in a web browser or as a hyperlink on a web page. However, as generally used herein, the term “bookmarklet” denotes any type of digital object embedded, inserted, or overlaid in on a user interface (UI) of a computing or communications platform, such as a web page, an application an application tool bar, a mobile application (app) user interface, and the like. The digital object can be a conventional bookmarklet, as widget, an applet, a plug-in, as button, as user-input-enabled site icon, a hyperlink, a pop-up, an input region, or any other type of user interface object configured to receive a user input. In one embodiment, the bookmarklet is embedded in a tool bar of a conventional web browser. In another embodiment, online retailers can embed a bookmarklet into a retailer webpage or a user interface display screen. The bookmarklet can be embedded in a manner that forms a correspondence between the bookmarklet and a gift option on the retailer webpage or user interface. When a gifter accesses the retailer's webpage or interface and finds a gift that the gifter wants to add to a giftee's gift page, the gifter can click the bookmarklet corresponding to the desired gift. As well-known to those of ordinary skill in the art, clicking a bookmarklet involves manipulating a user interface to select a particular command option or interface region in the user interface. As a result of clicking, the bookmarklet, a window, page, or user interface can be made to open, wherein the window, page, or user interface can include a list of giftees and occasions for gifting. The gifter can be given the option to select a particular giftee and optionally a particular occasion. Information indicative of the gift corresponding to the clicked bookmarklet can be added to a unique and personalized gift page or interface corresponding to a selected giftee. The giftee's personalized gift page or interface can be customized to conform to the selected occasion. The gifter can use the process described above to add multiple gift options to the giftee's personalized gift page or interface. Each gift option or offering can be presented on the giftee's personalized gift page or interface as an icon, a hyperlink, an image, a text block, a page, or other representation of the information indicative of the gift.

Once a gifter is satisfied with the one or more gift page offerings added to the unique and personalized gift page or interface corresponding, to a selected giftee, the gifter can “wrap” the gift page offerings and send an email invitation, a text message, or other online or offline notification to the selected giftee. The email invitation, text message, or other online or offline notification can include a customized link that will direct an online user to the giftee's personalized gift page or interface. The giftee can click on the customized link, which will direct the giftee to the giftee's personalized gift page or interface. On the giftee's personalized gift page or interface, the giftee can view the selection of gift page offerings being offered by the gifter. The giftee can be instructed or prompted to select a gift option(s) that they would like. The giftee can also be given the ability to indicate, “thank you, but no thank you,” or to communicate directly with the gifter to provide information to the gifter indicating how the gifter could improve the gift offerings by changing the color, size, etc. The giftee can also be given the ability to indicate a charity to which the gifter can make a donation in the name of the giftee in lieu of the giftee receiving a gift.

If the giftee selects a particular gift option, the gifter can receive confirmation of the giftee's selection via email or other form of electronic notification. The gifter can go back to their user dashboard or other user interface and see the gift selection. The gifter can click on a link corresponding to the gift selection and complete a purchase transaction for the selected gift. The giftee can receive the selected gift, purchased by the gifter, via standard online shipping options. When the giftee clicks on the customized link, affiliation codes, cookies, or the like can be added for tracking and financial purposes.

In an alternative embodiment, a mobile software application (app) installed on a mobile device (e.g., a smartphone or personal digital assistant) can be used to add gift items to a gift page, either by manual entry, or by using the mobile device, to take a picture of a barcode or Quick Response (QR) code associated with the gift item, which results in the app auto-populating information associated with the gift item on a gift page. In other embodiments, images of a desired gift item captured by the mobile device can be used to perform a search for similar items at online retailers. A voice interface on a mobile device can also be used for entering a product code associated with a particular desired gift item. Thus, items found in a variety of ways can enable the app to add the gift item to a gift page.

In a particular embodiment, financial transactions and shipping can be handled using standard suppliers. The gift selection invitation system of an example embodiment can be a social site where a gifter can save a selection of gifts to offer a giftee for their birthday, anniversary, graduation, holiday, or any gift giving occasion. Gifts can be sourced from any retailer or merchant on the Internet. Alternatively, information including images related to gifts can be manually loaded for gifts sourced from, for example, a small boutique that does not have website.

In the various embodiments described herein, the gift selection invitation system can improve the gift giving process by allowing a giftee to choose gifts that are personally picked by the gifter. This two-way communication allows the gifter to have the personal satisfaction of giving a thoughtful gift that is not just selected from a wishlist. The gift selection invitation system can also help to solve the problem of giving and receiving bad gifts, gifts that sit in a closet, get returned, or re-gifted.

### BRIEF DESCRIPTION OF THE DRAWINGS

The various embodiments is illustrated by way of example, and not by way of limitation, in the figures of the accompanying drawings in which:

FIG. 1 illustrates an example embodiment of a gift selection invitation system;

FIG. 2 illustrates a detail of an example bookmarklet used in an example embodiment;

FIG. 3 illustrates a sample retailer webpage including an embedded bookmarklet in the browser favorite's bar in an example embodiment;

FIG. 4 illustrates an example embodiment showing as drop-down menu displayed when gifter selects a bookmarklet corresponding to a particular gift item being added to a gift page being created by the gifter;

FIG. 5 illustrates a sample user interlace for configuring a new gift page in an example embodiment;

FIG. 6 illustrates a sample user interface with which a gifter can upload information pertaining to a gift option manually without the use of a bookmarklet in an example embodiment;

FIG. 7 illustrates a sample gift page from the gifter's perspective in an example embodiment;

FIG. 8 illustrates a sample gift page from the giftee's perspective in an example embodiment;

FIG. 9 illustrates a sample of the gift item selection confirmation page in an example embodiment;

FIG. 10 illustrates a sample of the gift item selection notification page sent to the gifter in an example embodiment;

FIG. 11 illustrates another example embodiment of a networked system in which various embodiments may operate;

FIG. 12 is a processing flow chart illustrating an example embodiment of an item delivery method as described herein; and

FIG. 13 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for inviting gift selection on a network-enabled interface are disclosed. In various embodiments, a software application program is used to enable the composition and delivery of as gift selection invitation interface using at computer system. As described in more detail below, the computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, set-top boxes, consumer electronic devices, or any other type of computing, data processing, conununication, networking, or electronic system.

Referring now to FIG. 1, in an example embodiment, a system for inviting gift selection on a network-enabled interface is disclosed. In various example embodiments, an application or service, typically provided by or operating on a host site (e.g., a website) 110, is provided to simplify and facilitate the downloading or hosted use of the gift selection invitation system 200 of an example embodiment. In a particular embodiment, the gift selection invitation system 200 can be downloaded from the host site 110 by a user at a user platform 140. Alternatively, the gift selection invitation system 200 can be hosted by the host site 110 for a networked user at a user platform 140. The details of the gift selection invitation system 200 of an example embodiment are provided below.

Referring again to FIG. 1, the gift selection invitation system 200 can be in network communication with a plurality of user platforms 140. The host site 110 and user platforms 140 may communicate and transfer data and information in the data network ecosystem 100 shown in FIG. 1 via a wide area data network (e.g., the Internet) 120. Various components of the host site 110 can also communicate internally via a conventional intranet or local area network (LAN) 114.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth, satellite, or modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to move freely and randomly and organize themselves arbitrarily, such that the topology of networks 120 and 114 may change rapidly and arbitrarily.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RIP, WAP, CDMA, TDMA, EDGE, UMTS, GPRS, GSM, UWB, WiFi, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The gift selection invitation interface can be implemented using any form of network transportable digital data. The network transportable digital data can be transported in any of a family of file formats, protocols, and associated mechanisms usable to enable a host site 110 and a user platform 140 to transfer data over a network 120. In one embodiment, the data format for the gift selection invitation interface can be HyperText Markup Language (HTML). HTML is a common markup language for creating web pages and other information that can be displayed in a web browser. In another embodiment, the data format for the gift selection invitation interface can be Extensible Markup Language (XML). XML is a markup language that defines a set of rules for encoding interfaces or documents in a format that is both human-readable and machine-readable. In another embodiment, a JSON (JavaScript Object Notation) format can be used to stream the interface content to the various user platform 140 devices. JSON is a text-based open standard designed for human-readable data interchange. The JSON format is often used for serializing and transmitting structured data over a network connection. JSON can be used in an embodiment to transmit data between a server, device, or application, wherein JSON serves as an alternative to XML.

In a particular embodiment, a user platform 140 with one or more client devices 141 enables a user to access data and provide data for the gift selection invitation system 200 via the host 110 and network 120. Client devices 141 may include virtually any computing device that is configured to send and receive information over a network, such as network 120. Such client devices 141 may include portable devices 144, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client, devices 141 may also include other computing devices, such as personal computers 142, multiprocessor systems, microprocessor-based or programmable consumer electronics, network PC's, and the like. Client devices 141 may also include other processing devices, such as consumer electronic (CE) devices 146 and/or mobile computing devices 148, which are known to those of ordinary skill in the art. As such, client devices 141 may range widely in terms of capabilities and features. For example, a client device configured, as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include as browser application enabled to receive and to send wireless application protocol messages (WAP), an for wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and/or send digital information. In other embodiments, mobile devices can be configured with applications (apps) with which the functionality described herein can be implemented.

Client devices 141 may also include at least one client application that is configured to send and receive content data or/or control data from another computing device via a wired or wireless network transmission. The client application may include as capability to provide and receive textual data, graphical data, video data, audio data, and the like. Moreover, client devices 141 may be further configured to communicate and/or receive a message, such as through an email application, as Short Message Service (SMS) direct messaging (e.g., Twitter), Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

As one option, the gift selection invitation system 200, or a port on thereof can be downloaded to a user device 141 of user platform 140 and executed locally on a user device 141. The downloading of the gift selection invitation system 200 application (or a portion titer can be accomplished using conventional software downloading functionality. As a second option, the gift selection invitation system 200 can be hosted by the host site 110 and executed remotely, from the user's perspective, on host system 110. In one embodiment, the gift selection invitation system 200 can be implemented as a service in a service-oriented architecture (SOA) or in as Software-as-a-Service (SAAS) architecture. In any case, the functionality performed by the gift selection invitation system 200 is as described herein, whether the application is executed locally or remotely, relative to the user.

Referring again to FIG. 1, the gift selection invitation system 200 of an example embodiment is shown to include a gift selection invitation system database 103. The database 103 is used in an example embodiment liar data storage of information related to the gift pages created and delivered, the gift items being offered and/or selected, the users involved in the gift exchange, and the control data for handling the gift exchange. It will be apparent to those of ordinary skill in the art that the database 103 can be used for the storage of a variety of data in support of the gift selection invitation system 200.

Referring again to FIG. 1, host site 110 of an example embodiment is shown to include a gift selection invitation system 200. Gift selection invitation system 200 can include as gift page creation module 210, a gift page invitation module 220, a selected gift fulfillment module 230, a user account management module 240, a user interface management module 250, and an administrative management module 260. Each of these modules can be implemented as software components executing within an executable environment of gift selection invitation system 200 operating on host site 110 or user platform 140. Each of these modules of an example embodiment is described in more detail below in connection with the figures provided herein.

Referring to FIG. 1, the gift selection invitation system 200 of an example embodiment can include a gift page creation module 210. The gift page creation module 210 is responsible for enabling a gifter to assemble a collection of gift options on a gift page for a particular giftee and optionally for a particular occasion, wherein the gift options can be sourced from a variety of different vendors, online retailers, offline retailers, merchants, or websites. In one embodiment, online retailers, website administrators, or an agent of host site 110 can embed a bookmarklet, applet, widget, or other form of digital object into a browser tool bar or a retailer or merchant webpage or a user interface display screen. A bookmarklet is unobtrusive script, typically written in JavaScript, for example, and stored as the Uniform Resource Locator (URL) of a bookmark in a web browser or as a hyperlink on a web page. En general, the bookmarklet is used to connect a merchant web page or user interface and a gift item listed thereon with a gift page, stored on or managed by a host site, for offering the gift item to a giftee. Online retailers, or the like, can embed a bookmarklet into a browser tool bar or a retailer webpage or a user interface display screen with an indication that the bookmarklet is associated with the gift selection invitation system of an example embodiment. As such, the bookmarklet can be embedded in a manner that forms a correspondence between the bookmarklet and a gift option on the retailer webpage or user interface. An example embodiment using a bookmarklet is described below in connection with FIGS. 2 through 5.

An alternative embodiment of the gift selection invitation system of an example embodiment provides an interface with which a gifter can upload information pertaining to a gift option manually without the use of a bookmarklet. In this manner, the gifter can explicitly assemble a collection, of gift options on a gift page for a particular giftee and optionally for a particular occasion, wherein the gift options can be sourced from a variety of different vendors, online retailers, websites, or sources not connected to the network. An example embodiment without the use of a bookmarklet is described below in connection with FIG. 6.

Referring now to FIG. 2, an example embodiment enables online retailers, website administrators, or an agent of host site 110 to embed a bookmarklet, such as the example bookmarklet 301 shown in FIG. 2, into a retailer webpage or a user interface display screen of, for example, a mobile device. In one embodiment, the bookmarklet 301 can be embedded into the favorite's bar or tool bar of as standard internet browser. This form of embedding a digital object into a favorite's bar or tool bar of a standard Internet browser is well-known to those of ordinary skill in the art. Alternatively, the bookmarklet, applet, widget, or other form of digital object can be embedded into a retailer webpage at any location on the page. Typically, the digital object can be embedded into the retailer webpage at a location proximate to or associated with to product or service offering on the retailer webpage. The associated product or service offering becomes a gift item option selected by a gifter, if the gifter selects, clicks on, or otherwise activates the corresponding bookmarklet, applet, widget, or other form of digital object embedded into the retailer webpage. An example of this correspondence between a bookmark let 301 and a sample retailer webpage 300 is shown in FIG. 3.

Referring now to FIG. 3, a sample retailer webpage 300 is shown to include an embedded bookmarklet 301 in the browser favorite's bar. The bookmarklet 301 includes a text label indicating the bookmarklet 301 is enabled to cause a gift item (e.g. Gift A in this example) offered on the retailer webpage 300 to be added to a gift page being created by a gifter. The gifter, browsing the retailer webpage 300, can decide to add the gift item shown on the retailer webpage 300 to a gift page being created by the gifter. The gifter can navigate as cursor control device, pointing device, or other type of user interface control mechanism to the location of the bookmarklet 301. Upon selection, clicking, or other form of activation of the bookmarklet 301, the drop-down menu 310 is displayed overlaying or adjacent to the retailer webpage 300. In an alternative embodiment, the drop-down menu 310 can be a pop-up window, widget, or other user interface object. In the example embodiment, the drop-down menu 310 provides additional control options for enabling the gifter to configure the gift option being added to the gift page. The details of these drop-down menu 310 control options in an example embodiment are described below in connection with FIG. 4.

Referring now to FIG. 4, an example embodiment illustrates the drop-down menu 310 displayed when a gifter selects a bookmarklet corresponding to a particular gift item being added to a gift page previously created or being currently created by the gifter. In the example embodiment, the gifter can manipulate user interface item 312 of drop-down menu 310 to select the name or identifier of a giftee for whom the gift page was created or is being created. If the gifter had previously identified the particular giftee as a potential gift recipient or previously created a gift page for the particular giftee, the gifter can use the user interface item 312 to select the desired giftee. If the gifter had not previously identified the particular giftee as a potential gift recipient and had not previously created a gift page for the particular giftee, the gifter can identify the particular giftee as a potential gift recipient and can use the user interface shown in FIG. 5 and described below to create a new gift page for the desired giftee.

Referring still to FIG. 4 in the example embodiment shown, the gifter can also manipulate user interface item 314 of drop-down menu 310 to select the name or identifier of a particular gift page associated with the selected giftee. In an example embodiment, a particular giftee can have a plurality of associated gift pages. If the gifter had previously created the desired gift page for the particular giftee, the gifter can use the user interface item 314 to select the desired gift page. If the gifter had not previously created the desired gift page for the particular giftee, the gifter can be prompted to create a new gift page for the desired giftee or an unnamed gift page for future gifts to potential giftees.

Referring still to FIG. 4, once the gifter has specified the giftee and giftee page identifiers as described above, the data associated with the particular gift item being added to the gift page as selected, by the gifter can be extracted from the retailer's webpage 300 and copied to display area 318 of the drop-down menu 310. Much of the information extracted from the retailer's webpage 300 can be auto-populated into the drop-down menu 310 for addition to the gift page. The gifter can manipulate user interface item 316 and display area 318 of drop-down menu 310 to edit the information associated with the gift item extracted from the retailer's webpage 300. Once the gifter is satisfied with the gift item information, the information associated with the particular gift item can be added to the specified giftee gift page when the user interface button 328 is clicked, selected, or otherwise activated by the gifter. Thus, in the manner described, a gifter can browse various retailer webpages on which a bookmarklet is embedded and click the bookmarklet to add a gift item from the retailer's webpage to a gift page of a specified giftee.

Referring now to FIG. 5, a sample user interface 320 for configuring a new gift page is shown. The user interface 320 is displayed for a gutter when the gifter has manipulated the user interface 310 or other user interface to indicate a desire to create a new gift page for a particular giftee. In the example embodiment, the gifter can manipulate user interface item 322 of user interface 320 to provide the name or identifier of the gift page being created. The gifter can also manipulate user interface item 324 of user interface 320 to enter a message for the particular giftee for whom the gift page is being created. This message is delivered to the giftee when the gift page is delivered to the giftee. The gifter can also manipulate user interface item 326 of user interface 320 to enter a date associated with the created gift page. For example, a gift page may be created by the gifter to offer a giftee a gift on their birthday. The date entered into user interface item 326 can be the birthday date. In the example embodiment, the date entered into user interface item 326 can be used to deliver the gift page to the giftee on or near the specified date.

As shown in the sample user interface 320 of an example embodiment, the gifter can also manipulate a variety of other parameters, data fields, information items, and other properties associated with the gift page. For example, the gifter can use various user interface items of user interface 320 to specify whether the gifter wants to receive a reminder notification prior to delivery of the gift page, whether the giftee is allowed to select more than one gift item from the gift page, whether gift prices should be displayed for the giftee on the gift page, and whether gift items shown on the gift page should be enabled to provide links to corresponding retailer product pages or websites. It will be apparent to those of ordinary skill in the art that a variety of other properties of a particular gift page can be similarly configured.

Referring now to FIG. 6, an example illustrates a sample user interface with which a gifter can upload information pertaining to a gift option manually without the use of a bookmarklet in an example embodiment. In some cases, it may not be possible or feasible to embed a bookmarklet in the browser tool bar or on the webpage of a particular retailer or merchant. In other cases, particular desired gift items may not be available online. In these cases, an example embodiment enables the sifter to manually add the desired gift item to a gift page of a particular giftee. As shown in FIG. 6, the user interface 330 can be used to enable the gifter to specify a gift item by entering information related to the gift item in response various prompts from the user interface 330. For example, the gifter can be prompted to enter various attributes of the gift item including: the title, name or identifier of the gift item, the size, color, the price (optionally), the quantity, the style, model, make, manufacturer, etc. of the gift item. The gifter can also be prompted to add a picture, photo, image, a video or audio clip, or other file or document related to the gift item, which can be uploaded to the host 110 site using well-known techniques. The gifter can also be prompted to include a textual description and/or notes related to the gift item. Finally, the gifter can be prompted to specify a web address, a uniform resource locator (URL), an Internet Protocol (IP) address, or other form of network address or identifier that can be used as a source for information related to the gift item or as a source for the gift item itself. The information collected from the gifter in response to the various prompts from the user interface 330 can be added to the desired gift page specified by the gifter in the manner described above.

FIG. 7 illustrates a sample gift page 340 from the gifter's perspective in an example embodiment. As described above, the gifter can use several methods described herein to add desired gift items (or information related thereto) to a gift page for a particular giftee. In one embodiment, a digital object (e.g., a bookmarklet) can be embedded into a gifter's browser tool bar or a retailer webpage in association with a particular product or service offering on the retailer webpage. In another embodiment, the giftee can manually provide information related to a particular product or service offering. In either ease, the information related to the particular product or service offering (e.g., the gift item) can be added to a gift page associated with a particular giftee. FIG. 7 illustrates an example of such a gift page on which several gift items have been added to the gift page 340 in the manner(s) described above. As shown in the sample gift page 340, each gift item representation on the gift page 340 can include a set of descriptive information related to the gift item, the descriptive information including: a picture, photo, or image of the gift item, and information related to various attributes of the gift item including: the title, name or identifier of the gift item, the size, color, the price (optionally), the quantity, the style, model, make, manufacturer, etc. of the gift item, a link to a video clip, audio clip, or other file or document related to the gift item, and a textual description and/or notes related to the gift item. The descriptive information for each gift item representation on the gift page 340 can also include a web address, a uniform resource locator (URL), an Internet Protocol (IP) address, or other form of network address or identifier that can be used as a source for information related to the gift item or as a source for the gift item itself. The gifter is offered the option to edit or delete any of the gift item options included in the giftee's gift page. The presentation of the gift item representations on the gift page are also configured to conform to the various parameters set by the gifter on the gift page configuration interface 320 described above. Once the gifter is satisfied with the gift item options included in the particular giftee's gift page, the gifter is ready to dispatch the gift page to the particular giftee. In an example embodiment, the processing operations related to dispatching the gift page to the particular giftee are handled by the gift page invitation module 220. The processing operations performed by the gift page invitation module 220 are described below.

Referring again to FIG. 1, the gift selection invitation system 200 of an example embodiment can include a gift page invitation module 220. The gift page invitation module 220 is responsible for enabling a gifter to send a gift page (or a notification/invitation thereof) to a particular giftee at a particular time. As part of this process, the gifter specifies the name or identity of the giftee and the name or identity of a corresponding gift page that the gifter has created for the giftee in the manner described above. The gifter can select from any of a plurality of gift recipients in a contact list, address book, or via a direct entry of a name and a delivery address corresponding to the name. The gift page invitation module 220 is responsible for delivering the specified gift page (or a notification/invitation thereof) to the specified giftee. The gift page invitation module 220 also con forms the deliver of the gift page to the various parameters set by the gifter on the gift page configuration interface 320 described above. For example, the gift page may be configured for a particular occasion (e.g., as birthday) associated with a particular date. The gift page invitation module 220 can hold the gift page delivery request until the date associated with the particular occasion arrives. On or near the related date, the gift page invitation module 220 can deliver the gift page (or a notification/invitation thereof) to the specified giftee. Additionally, as configured on the gift page configuration interface 320, the gifter can be notified prior to the particular date that delivery of the gift page is imminent. The gift page (or a notification/invitation thereof can be delivered to the specified giftee in a variety of ways, including: email, chat, instant message, text message, email or text message with an attachment, fax, postal mail, or any other conventional delivery mechanism. In an alternative embodiment, a notification/invitation can be sent to the giftee to inform the giftee that a gift page is ready to be viewed at a given web address or network location. A link to the network location of the gift page can be included in the notification/invitation. Upon activation of the link sent to the giftee, the giftee can view the gift page created especially for them by the gifter. A sample gift page is shown in FIG. 8 and described below.

Referring now to FIG. 8, the diagram illustrates a sample gift page 350 from the giftee's perspective in an example embodiment. The gift page 350 includes the collection of gift item representations assembled by the gifter as described above. The gift page 350 can include a variety of prompts that offer the giftee several options in regard to the gift page 350. First, the giftee can be prompted to select one or more gift items from the gift page 350 by clicking on the corresponding gift item representations. The giftee cart also click on a button related to any of the gift item representations to get more detail on the gift item. Using the gift page configuration interface 320 described above, the gifter can configure the gift page 350 to enable the giftee to select one or to multiple of gift items from the gift page 350. The gifter can also determine whether a giftee can see the prices and merchant URLs on the gift page 350. Secondly, the giftee can be given the ability to refuse all of the gifts by replying to the gifter with a, “Thank you, but no thank you” button, which sends a corresponding message to the gifter. Thirdly, the giftee can be given the ability on the gift page 350 to view a message from the gifter as part of the gift item collection. Finally, the giftee can be prompted on the gift page 350 to communicate directly with the gifter about how to make the gift offering better suited to the giftee's taste. For example, the giftee can advise the gifter in the communication that gift options with a different color, size, style, etc. would be more to the giftee's liking. This communication from the giftee to the gifter via the gift page 350 enables the giftee to guide the gifter toward a more desired gift item collection. Further, the communication can be used by the giftee to direct the gifter to a giftee's wish list previously created by the giftee on the host site 110. In a particular embodiment, the giftee is given a predetermined length of time on the gift page 350 to select one or more gift items, decline a gift item, or communicate with the gifter.

If the giftee elects to decline a gift item or communicate with the gifter, a message to that effect is sent to the gifter via any of the message delivery mechanisms described above. If the giftee selects one or more gift items from the gift page 350, a confirmation page is displayed for the giftee. A sample of the gift item selection confirmation page is shown in FIG. 9. In an example embodiment, the gift item selection confirmation page displays the gift item representations that the giftee has selected from the gift page 350. The gift item selection confirmation page also prompts the giftee for the entry of a shipping address to where the selected gift items can be shipped. The gift item selection confirmation page can also prompt the giftee to enter a note for the gifter. Once the giftee completes the gift item selection confirmation page and activates the Submit button, a gift item selection notification page is sent to the gifter informing the gifter of the giftee's item selections. The gift item selection notification page sent to the gifter can also include the note to the gifter entered by the giftee on the gift item selection confirmation page. FIG. 10 illustrates a sample of the gift item selection notification page sent to the gifter in an example embodiment.

Referring now to FIG. 10, a sample of the gift item selection notification page sent to the gifter in an example embodiment is illustrated. At this point in the process, the giftee has selected one or more gift items from the gift page 350 originally created by the gifter as described above. The gifter can use the gift item selection notification page, such as the sample page shown in FIG. 10, to approve, the fulfillment of the selected gift items. The gift fulfillment operation of an example embodiment is handled by the selected gift fulfillment module 230 (see FIG. 1 as described below.

In an example embodiment, important user shopping behavior information and affinity information can be gathered and tracked using the gift pages of the example embodiment. For example, when the creating the gift page for a particular giftee, the gifter can be prompted for particular information related to the giftee, such as the giftee's gender, age, and occasion for which a gift is being sent. This information can be used to classify the giftee into various demographic groups that may be beneficial for retailers or marketers. Additionally, the giftee's behavior related to the gift page may yield information beneficial for retailers or marketers. For example, the particular gift selected by the giftee relative to the other gift options may provide valuable clues as to the giftee's affinity for particular types of products. This shopping behavior information and affinity information can be captured as the giftee selects one or more gift items from the gift page 350. The shopping behavior information and affinity information can be retained in a database and collected for a plurality of gifters and giftees.

Referring again to FIG. 1, the gift selection invitation system 200 of an example embodiment can include a selected gift fulfillment module 230. The selected gift fulfillment module 230 is responsible for enabling a gifter to complete the purchase of the giftee-selected gift items and to authorize shipment of the selected gift items to the giftee. As part of this process, the gifter receives a link or URL corresponding to each gift item as part of the gift item selection notification page shown in FIG. 10. Referring again to FIG. 10, the gifter can use the gift item links to access a merchant website corresponding to the selected gift item(s). The gifter can use the merchant website to complete the purchase of the selected gift item using standard online purchase procedures. The gifter can also convey the address of the giftee to the merchant website so the merchant can effect delivery of the selected gift item directly to the giftee. As an alternative, the gifter can also have the gift item delivered from the merchant to the gifter so the gifter can give the selected gift item to the giftee.

In a particular embodiment, affiliate links can be added to gift item options as the gift item options are added to the gift pages. When a gift item representation with an affiliate link, is selected from a gift page by a giftee and purchased by the gifter, a pre-determined revenue portion associated with the affiliate referral can be generated. Additionally, advertising can be added to the gift pages created by the gifter and accessed by the giftee. Advertisements can be added to webpages using well-known tools and processes.

In a particular embodiment, a gifter can forward a gift page to a third party (other than the giftee) for comments on the proposed collection of gift items on the gift page. The third party user can enter comments, which are conveyed back to the gifter. In this manner, friends, family members, or others can review and comment on a set of gift options proposed by a gifter for a particular giftee. This feature of the example embodiment helps to prevent the gifter from giving gifts that are not needed or gifts that the giftee already has, thus improving the gifting tradition, preventing returns of items, etc.

Referring again to FIG. 1, the gift selection invitation system 200 of an example embodiment is shown to include a user account management module 240. The user account management module 240 can be used to create and maintain a user account on the host site 110. The user account management module 240 can also be used to configure user settings, create and maintain a user/user profile on host site 110, and otherwise manage user data and operational parameters on host site 110.

Referring again to FIG. 1, the gift selection invitation system 200 of an example embodiment is shown to include a user interface management module 250. The user interface Management module 250 handles the presentation of various user interface displays, display screens, windows, frames, or the like. In one embodiment, the user interface can be implemented as a series of web pages. In another embodiment, the user interface can be implemented as a series display screens on a mobile device as implemented by a mobile application or app. In yet another embodiment, the user interface can be implemented as a series of voice command/responses implemented using conventional voice recognition and voice synthesis technology on a mobile device as implemented by a mobile application or app. These various user interface displays are provided to present information and gift pages to a user of the gift selection invitation system 200 of an example embodiment. The user interface management module 250 also receives user inputs and configures the various user interface displays in conformity with the user inputs, command selections, and the like.

Although the various user interface displays provided by the user interface management module 250 are nearly infinitely varied, several sample user interface displays and sequences are provided herein and in the corresponding figures to describe various features of the disclosed embodiments. These sample user interface displays and sequences are described above.

Referring again to FIG. 1, the gift selection invitation system 200 of an example embodiment is shown to include an administrative management module 260. The administrative management module 260 can be used by an agent of the gift selection invitation system 200 to manage user accounts and to manage the creation and delivery of gift pages.

Referring now to FIG. 11, another example embodiment 101 of a networked system in which various embodiments may operate is illustrated. In the embodiment illustrated, the host site 110 is shown to include the gift selection invitation system 200. The gift selection invitation system 200 is shown to include the functional components 210 through 260, as described above. In a particular embodiment, the host site 110 may also include a web server 404, having a web interface with which users may interact with the host site 110 via a user interface or web interface. The host site 110 may also include an application programming interface (API) 402 with which the host site 110 may interact with other network entities on a programmatic or automated data transfer level. The API 402 and web interface 404 may be configured to interact with the gift selection invitation system 200 either directly or via an interface 406. The gift selection invitation system 200 may be configured to access a data storage device 103 and data 408 therein either directly or via the interface 406.

Referring now to FIG. 12, a processing flow diagram illustrates an example embodiment of a gift selection invitation system 200 as described herein. The method 500 of an example embodiment includes: enabling a gifter to create, by use of a network-connectable data processor, a gift page including a plurality of gift item options sourced from a plurality of gift sources (processing block 510); enabling the gifter to identify a giftee for whom the gift page is created (processing block 520); causing, by use of the data processor, delivery of a notification to the giftee, the notification including to link to the gift page (processing block 530) enabling the giftee to select one or more gift item options from the gift page (processing block 540); communicating the selected gift item options to the gifter (processing block 550); and enabling the gifter to effect fulfillment of the selected gift item options (processing block 560).

FIG. 13 shows a diagrammatic representation of a machine in the example form of a computer system 700 within which as set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of as server or a client machine in server-client network environment, or as a peer machine in a peer-to-peer (or distributed) network environment. The machine may be a personal computer (PC), a tablet PC, a set-top box (SIB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” can also be taken to include any medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 CFR. §172(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted, as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
enabling a gifter to create, by use a network-connectable data processor, a gift page including a plurality of gift item options sourced from a plurality of gift sources;
enabling the gifter to identify a giftee for whom the gift page is created;
causing, by use of the data processor, delivery of a notification to the giftee, the notification including a link to the gift page;
enabling the giftee to select one or more gift item options from the gift page;
communicating the selected gift item options to the gifter; and
enabling the gifter to effect fulfillment of the selected gift item options.

2. The method as claimed in claim 1 further including embedding a bookmarklet in a tool bar of a browser.

3. The method as claimed in claim 1 further including embedding a bookmarklet in a webpage.

4. The method as claimed in claim 2 further including enabling the gifter to use the bookmarklet to select a gift item option for inclusion on the gift page.

5. The method as claimed in claim 1 further including using a user interface to manually add a gift item option to the gift page.

6. The method as claimed in claim 1 wherein the notification is an online notification.

7. The method as claimed in claim 1 wherein the notification is a text message.

8. The method as claimed in claim 1 further including enabling the gifier to selectively allow or disallow the giftee to select multiple gift item options from the gift page.

9. The method as claimed in claim 1 further including enabling the gifter to selectively allow or disallow the giftee to see a price corresponding to a gift item option on the gift page.

10. The method as claimed in claim 1 further including enabling the giftee to use the gift page to decline selection of any gift item options.

11. The method as claimed in claim 1 further including enabling the giftee to use the gift page to communicate with the gifter.

12. A system comprising:
a data processor;
a network interface, in data communication with the data processor, for communication on a data network; and
a gift selection invitation system, executable by the data processor, to:
enable a gifter to create a gift page including a plurality of gift item options sourced from a plurality of gift sources;
enable the gifter to identify a giftee for whom the gift page is created;
cause delivery of a notification to the giftee, the notification including a link to the gift page;
enable the giftee to select one or more gift item options from the gift page;
communicate the selected gift item options to the gifter; and
enable the gifter to effect fulfillment of the selected gift item options.

13. The system as claimed in claim 12 being further configured to embed a bookmarklet in a tool bar of a browser.

14. The system gas claimed in claim 12 being further configured to embed a bookmarklet in a webpage.

15. The system as claimed in claim 13 being further configured to enable the gifter to use the bookmarklet to select a gift item option inclusion on the gift page.

16. The system as claimed in claim 12 being further configured to enable the gifter to use a user interface to manually add a gift item option to the gift page.

17. The system as claimed in claim 12 wherein the notification is an online, notification.

18. The system as claimed in claim 12 wherein the notification is a text message.

19. A non-transitory machine-useable storage medium embodying instructions which, when executed by a machine, cause the machine to:
enable a gifter to create a gift page including a plurality of gift item options sourced from a plurality of gift sources;
enable the gifter to identify a giftee for whom the gift page is created;
cause delivery of a notification to the giftee, the notification including to link to the gift page:
enable the giftee to select one or more gift item options from the gift page;
communicate the selected gift item options to the gifter; and
enable the gifter to effect fulfillment of the selected gift item options.

20. The non-transitory machine-useable storage medium as claimed in claim 19 being further configured to embed a bookmarklet in a tool bar of a browser or in a webpage laid to enable the gifter to use the bookmarklet to select a gift item option for inclusion on the gift page.
